(19) United States
(12) Patent Application Publication
(10) Pub. No.: US 2020/0130836 A1
(43) Pub. Date: Apr. 30, 2020

(54) Remotely Actuated Modular Systems Mount

(71) Applicant: Bell Helicopter Textron Inc., Fort Worth, TX (US)

(72) Inventors: Abey Mathew Kurikesu, Fort Worth, TX (US); Jeremy Robert Chavez, Colleyville, TX (US); Steven Wayne Kihara, North Richland Hills, TX (US)

(73) Assignee: Bell Helicopter Textron Inc., Fort Worth, TX (US)

(21) Appl. No.: 15/893,628

(22) Filed: Feb. 10, 2018

(51) Int. Cl. B64D 9/00

(52) U.S. Cl. CPC B64D 9/00; B64D 7/06

(57) ABSTRACT

A mounting system configured for coupling a device to a vehicle and providing for movement and remote operation of the device includes a first member for removably coupling the device to the mounting system, a second member rotatably coupled to the first member, a rotational actuator configured to rotate the first member relative to the second member about a first axis, a linear actuator configured to move the first and second members together, a device actuator configured to operate the device, and a deployment apparatus configured to move the device from a stored position to a deployed position.

### BACKGROUND

Combat helicopters have traditionally been equipped with weapons mounted on their nose and/or on either side of the fuselage. However, tiltrotor aircraft present unique challenges to utilization of the traditional helicopter armaments. For example, due to their ability to fly in an airplane configuration, tiltrotor aircraft are capable of travelling much faster, and further, than helicopters. As the speed of an aircraft increases, the importance of the aerodynamic properties thereof increase as well. As such, mounting weapons on the exterior of the fuselage, or in open doorways of the aircraft, would create additional drag which would diminish the speed and range of the aircraft, thereby undercutting the very benefits sought to be gained from utilizing a tiltrotor aircraft.

Tiltrotor aircraft are not generally utilized as attack aircraft. Instead, their primary mission involves troop and/or equipment insertion and extraction. During insertion and extraction operations, it is necessary to hover close to the ground or land the aircraft. It is during these insertion and extraction maneuvers that the aircraft is most exposed to attack and is need of defensive weapons. Weapon mounts for tiltrotor aircraft have been developed for the nose and the belly of the aircraft. However, the nose mounted weapon can only cover the front of the aircraft and the belly mounted weapon is horizontally blocked by the landing gear in hover mode and is virtually useless while the aircraft is on the ground. Moreover, if the aircraft crashes, a belly mounted weapon would be rendered unusable. Accordingly, there is a need for other solutions not currently provided.

### BRIEF DESCRIPTION OF THE DRAWINGS

FIG. 1 is a side view of an aircraft including a remotely actuated device mounting system, according to this disclosure.

FIG. 2 is a side view of a tail portion of the aircraft of FIG. 1

FIG. 3 is a side view of the aircraft and the remotely actuated device mounting system of FIG. 1.

FIG. 4 is a side view of a tail portion of the aircraft and the remotely actuated device mounting system of FIG. 1.

FIG. 5 is a top view of the aircraft and the remotely actuated device mounting system of FIG. 1.

FIG. 6 is a top view of a tail portion of the aircraft and the remotely actuated device mounting system of FIG. 1.

FIG. 7 is a side view of another embodiment of a remotely actuated device mounting system.

FIG. 8 is a side view of the remotely actuated device mounting system of FIG. 7.

FIG. 9 is a side view of a telescoping attachment for use with a remotely actuated device mounting system.

FIG. 10 is an oblique view of another embodiment of a remotely actuated device mounting system, according to this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure provides a remotely actuated, modular, device mounting system and an aircraft for use thereon. The mounting system may include a member configured to couple a device thereto, a mechanism capable of modifying the directional orientation of the device, and a mechanism for deploying the device from a stored to a deployed position. While the mounting system is shown, and discussed for use with, a tiltrotor aircraft, the disclosed mounting system could be used on any vehicle or mobile structure. As such, the claims appended hereto should not be interpreted as limiting the mounting system to use on a particular vehicle type unless specifically stated therein. Moreover, while the mounting system is described primarily as a weapon mount, it may be used for mounting any implement that benefits from directional use. For example, the mount may be used with optical sensors, search lights, water hoses, camera systems, acoustic systems, directed energy weapons, etc.

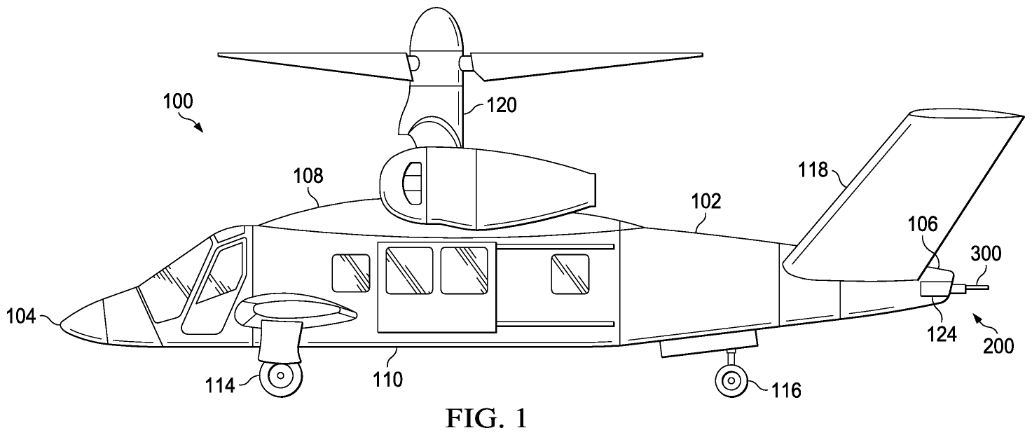

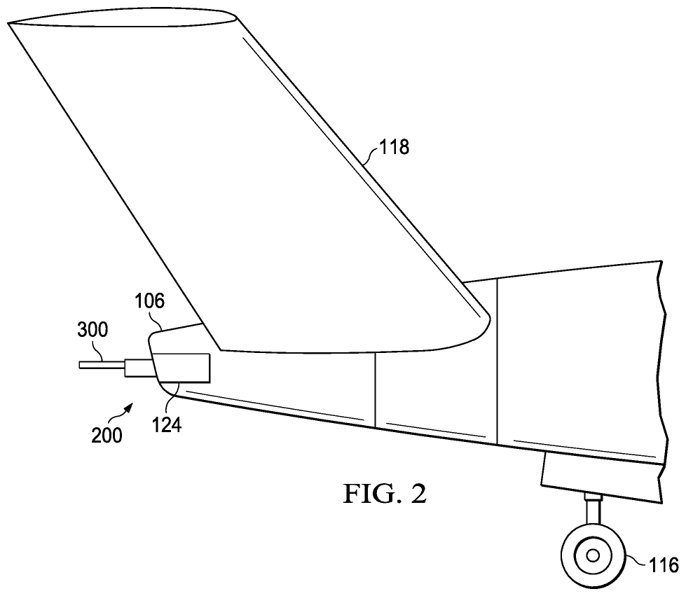

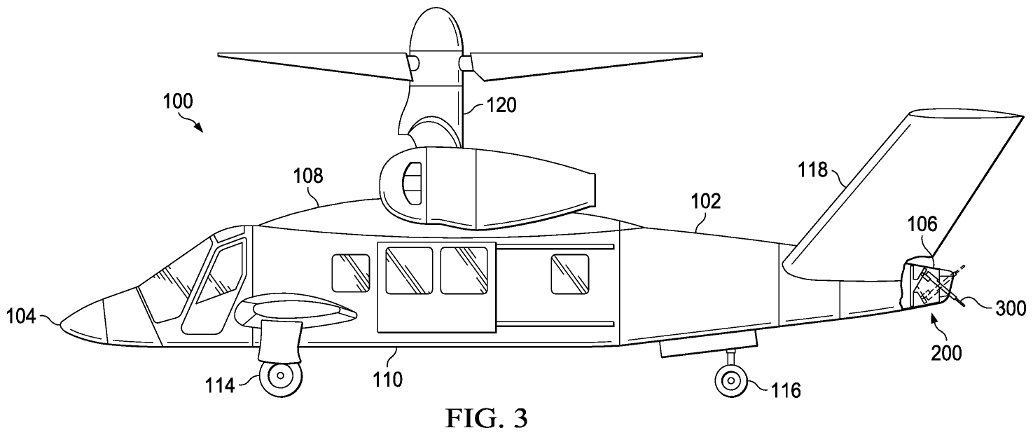

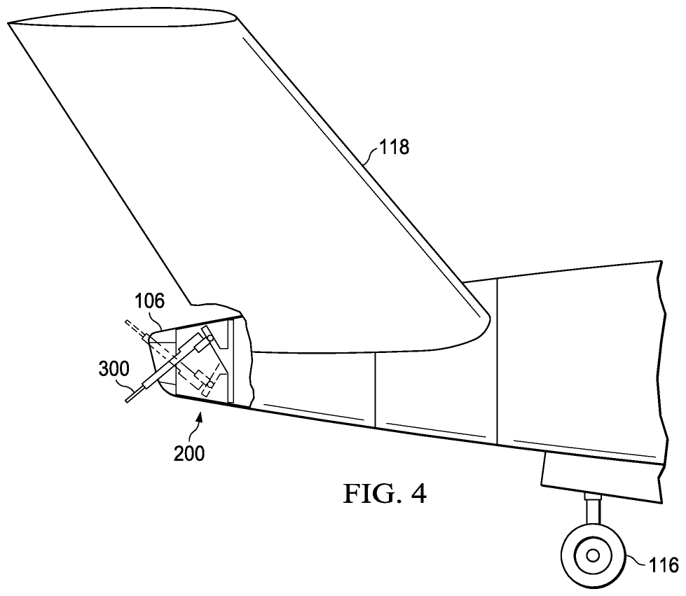

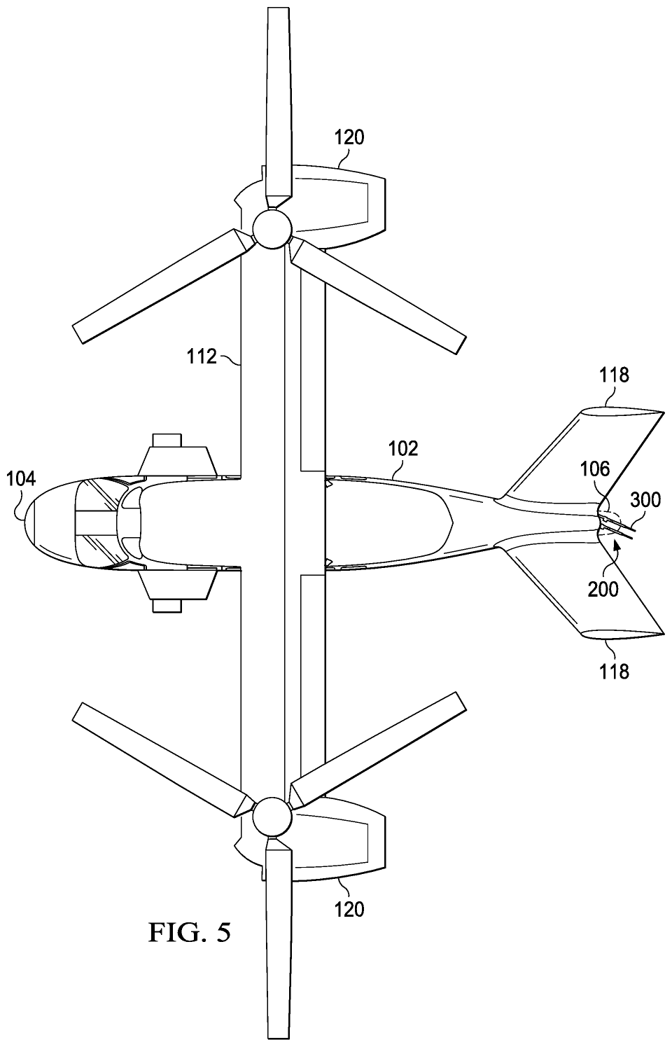

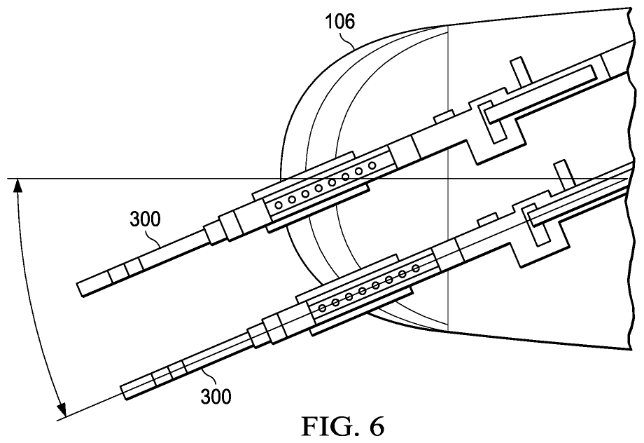

FIGS. 1-6 illustrate an aircraft 100 having a fuselage 102 with a front end 104, a tail end 106, a top portion 108, and a bottom portion 110. Aircraft 100 further includes a wing 112 extending from top portion 108, as well as forward landing gear 114 and rear landing gear 116 extending from bottom portion 110. Aircraft 100 also includes a pair of tail fins 118 extending from tail end 106 and a pair of tiltrotor assemblies 120 coupled to opposite ends of wing 112. Located within tail end 106 is a mounting system 200. Mounting system 200 provides for the remote operation of one or more devices 300 coupled thereto. For purposes of example only, device 300 is shown throughout as a firearm. FIGS. 2, 4, and 6 focus on portions of aircraft 100 that illustrate the ability to move device 300 relative to aircraft 100.

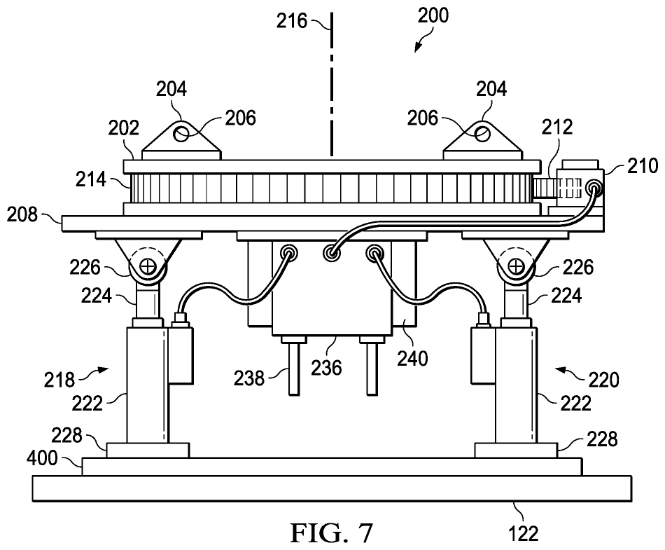

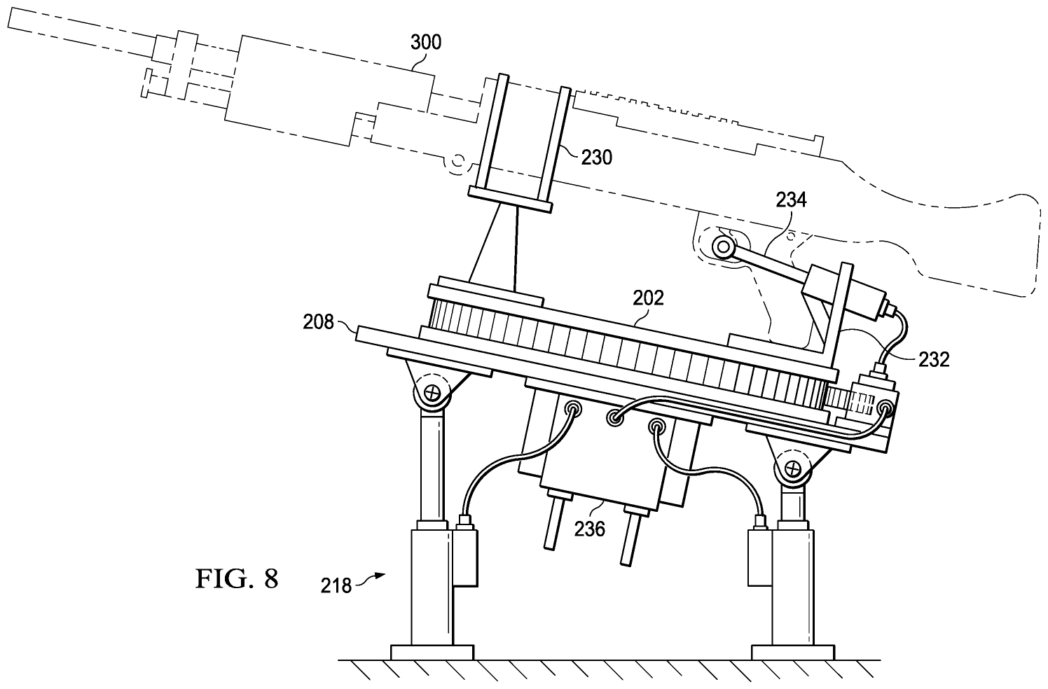

As shown in FIGS. 7 and 8, mounting system 200 may include a first member 202 configured for removably coupling device 300 thereto. Coupling of device 300 to first member 202 may be accomplished, for example, using a plurality of tabs 204 extending from first member 202. Tabs 204 include holes 206 extending therethrough for the receipt of pins (not shown) to retain device 300 thereto. Device 300 may be coupled to first member 202 utilizing a quick release mechanism that enables installation and removal of device 300 from mounting system 200 without the use of a tool. This quick-release configuration permits an operator to quickly remove and utilize device 300 separate from mounting system 200 without requiring any modification of device 300. Mounting system 200 may further include dampers configured to absorb recoil from device 300.

Mounting system 200 further includes a second member 208 rotatably coupled to first member 202. Relative rotation between first member 202 and second member 208 may be accomplished by a rotational actuator 210, coupled to second member 208, turning a drive gear 212. Drive gear 212 turns a driven gear 214 which is coupled to first member 202, thereby causing rotation of first member 202 relative to second member 208 about a first axis 216. As shown, rotational actuator 210 comprises an electric motor. However, rotational actuator 210 may be hydraulic or pneumatic. In addition, alternative mechanisms for causing relative rotation between first member 202 and second member 208 may also be used. For example, rotational actuator 210 may be centrally located on first axis 216 so that rotational actuator 210 may directly drive first member 202, rotation may be chain or belt driven, rotation may be affected by a linear actuator pushing or pulling on a lever, or any other means of causing rotation. It should also be understood that rotational actuator 210 may be coupled to either first member 202 or second member 208 and drive the other member.

Rotation of first member 202 and second member 208, and therefore, device 300, orthogonally to first axis 216 may be facilitated by a first linear actuator 218 alone or in combination with a second linear actuator 220. Both first and second linear actuators 218, 220 include an outer sleeve 222 and an inner member 224 contained at least partially within outer sleeve 222, wherein inner member 224 is configured to extend and retract linearly from within outer sleeve 222. If first linear actuator 218 is utilized by itself, inner member 224 of first linear actuator 218 is rotatably coupled to second member 208 proximate a first end of second member 208 while an opposite second end of second member 208 is rotatably coupled to a fixed pivot (not shown). Rotatable coupling of inner member 224 may be facilitated by a revolute joint 226 or any other suitable connection that permits rotation of second member 208 relative to inner member 224. In the single linear actuator configuration, actuation of first linear actuator 218 affects rotation of first member 202 and second member 208 about a fixed axis passing through the fixed pivot.

Alternatively, if first linear actuator 218 and second linear actuator 220 are both utilized, both inner members 224 are rotatably coupled to second member 208 and outer sleeves 222 are coupled to an airframe 122 or a deployment apparatus 400 (discussed below). Outer sleeves 222 may include a base 228 configured for attachment to airframe 122 or deployment apparatus 400. Bases 228 are preferably equipped with quick release mechanisms that enable installation and removal of mounting system 200 from aircraft 100 without the use of a tool. This feature enables an operator to quickly remove and utilize device 300 along with mounting system 200 independent from aircraft 100. Extending both first and second linear actuators 218, 220 will cause translation of first and second members 202, 208. Extension or retraction of only one of first and second linear actuators 218, 220 or uneven extension and/or retraction of both will cause rotation. Linear actuators 218, 220 are shown as an electromagnetic linear actuators. However, first and second linear actuators 218, 220 may be fluid or gas driven pistons or any other suitable linear actuation devices. It should be understood that mounting system 200 may include more than one first linear actuator 218 and/or more than one second linear actuator 220. Moreover, other mechanisms for providing rotation orthogonal to first axis 216 may be utilized. For example, a system similar to that which provides rotation about first axis 216 may be attached to second member 208 in an orthogonal orientation to affect rotation perpendicular to first axis 216. That is, a second rotational actuator (not shown) may be coupled between airframe 122 and second member to enable rotation.

As shown in FIG. 8, mounting system 200 may further include a first bracket 230 and a second bracket 232, sized and shaped to hold specific devices. For example, if mounting system 200 is to be used with a firearm, it may be advantageous to mount that firearm without any modifications that would prevent it's handheld use by an operator. As such, first bracket 230 may be sized and shaped to securely fasten a fore grip of the firearm and second bracket 232 may be sized and shaped to securely fasten a pistol grip of the firearm to first member 202. Moreover, mounting system 200 includes a device actuator 234 configured to operate device 300. In the firearm example, device actuator 234 would be configured to pull a trigger of the firearm. As discussed above, while the example shown is for a firearm, it should be understood that first and second brackets 230, 232 and device actuator 234 may be configured for securing and operating any device 300. Moreover, first and second brackets 230, 232 and device actuator 234 may be directly coupled to first member 202 or they may be coupled to tabs 204, thereby permitting different brackets to be attached for different devices. In addition, other accessories may be included such as actuators designed to pull a charging handle, change magazines, and to depress a bolt release.

Mounting system 200 is configured for remote operation. Remote operation of mounting system 200 is enabled by a controller (not shown) in electronic communication with a control unit 236. The controller may be wired, wireless, or configured to function both wired and wirelessly. The controller may have a form similar to a joystick, a video game controller, a touchscreen tablet, or any other device suitable for remote control. The controller includes inputs for receipt of control instructions from an operator. The controller also includes a transmitter configured to transmit corresponding control signals to control unit 236. The controller may also include a screen configured to display video and other data pertaining to the operation of device 300.

Like the controller, control unit 236 may be wired, wireless, or configured to function both wired and wirelessly. Control unit 236 includes a processor configured to receive the control signals and calculate and transmit the necessary movement signals to rotational actuator 210, first linear actuator 218, second linear actuator 220, and device actuator 234, as well as any other accessories that may be included on mounting system 200. Signal reception of control unit 236 may be enhanced by wireless antennae 238. Control unit 236 may further include a power source 240 configured to power rotational actuator 210, first linear actuator 218, second linear actuator 220, and device actuator 234, as well as any other accessories that may be included on mounting system 200. Power source 240 may also be configured to power device 300 if device 300 requires power. Power source 240 may comprise one or more battery packs. Power source 240 may also include a mechanism for recharging, such as solar panels. Control unit 236 may also be configured to connect to a power supply on aircraft 100 and only rely on power source 240 when mounting system 200 is removed from aircraft 100 or if aircraft 100 loses power.

Control unit 236 may also include sophisticated stabilization and targeting hardware and software. For example, control unit 236 may include accelerometers and a laser range finder to account for relative motion of aircraft and the distance to targets and utilize software to automatically adjust the point of aim of device 300.

Mounting system 200 may provide the ability to move device 300 from a stored position within fuselage 102 to a deployed position wherein operation of the device may be affected outside fuselage 102. This is facilitated by a deployment apparatus 400. Deployment apparatus 400 may be configured to translate mounting system 200, and therefore device 300 therewith, from the stored position to the deployed position. The translation may be horizontal or vertical. Deployment apparatus 400 may include bearing slide rails to permit movement and at least one actuator to control the movement along the rails. Generally, horizontal deployment would extend device 300 directly from the rear of aircraft 100, while vertical deployment would lower device 300 below bottom portion 110 behind rear landing gear 116. Alternatively, deployment apparatus 400 may be configured to rotate mounting system 200, and device 300, from the store position to the deployed position. Deployment apparatus 400 may rotate 180 degrees such that the deployed position is completely inverted from the stored position. Alternatively, deployment apparatus may rotate down like a tailgate.

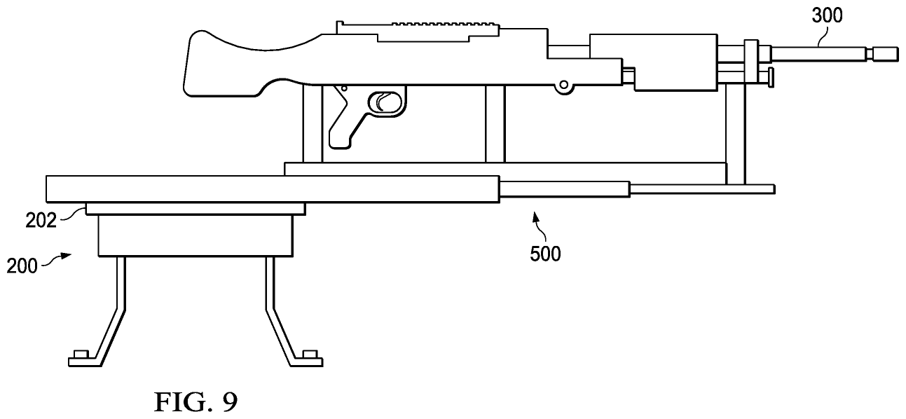

FIG. 9 shows another deployment apparatus, a telescoping arm 500. Telescoping arm 500 is configured to attach to first member 202 and device 300 is coupled to telescoping arm 500. Accordingly, telescoping arm 500 does not move mounting system 200, but rather only extends device 300 from the stored position to the deployed position. Telescoping arm 500 may comprise a plurality of nested shafts moved by a linear actuator.

Depending on which type of deployment method is to be used, different openings in fuselage 102 may be required. As such, a moveable panel 124 may be located at tail end 106 of aircraft 100. Moveable panel 124 may take one of several forms. Moveable panel 124 may comprise one or more panels that rotate or slide from a closed position to an open position, thereby creating a large opening through with device 300 may be operated. The opening should permit maximum horizontal and vertical movement of device 300 while in the deployed position. Alternatively, it may be preferred to have the opening remain smaller and have the opening configured such that moveable panels 124 actively move with the movement of device 300 while in use. In still another embodiment, moveable panel 124 may be attached to mounting system 200 or deployment apparatus 400 such that moveable panel 124 is lowered with mounting device from bottom portion 110 or is rotated from outside to inside fuselage 102 during deployment of device 300.

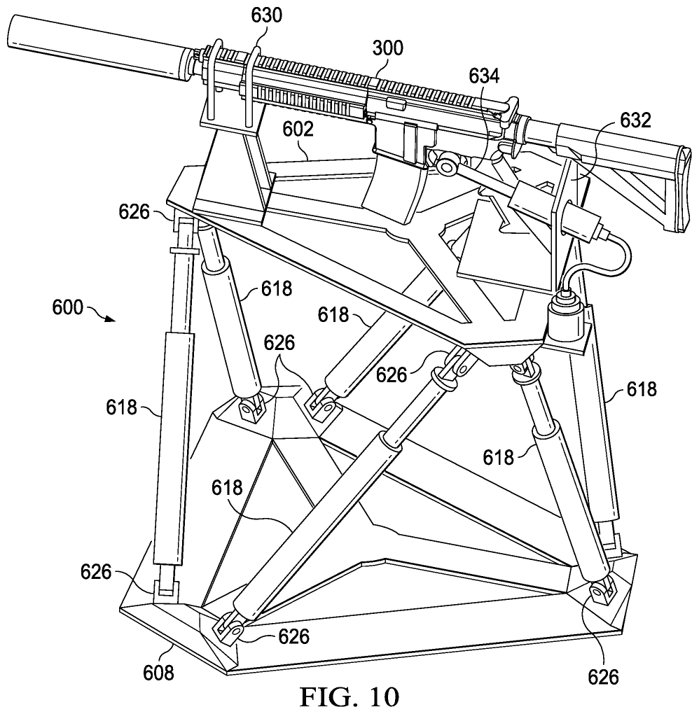

FIG. 10 shows another mounting system 600. Mounting system 600 includes a first member 602 configured for removably coupling device 300 thereto. First member 602 may include a first bracket 630 and a second bracket 632, sized and shaped to hold device 300. For example, if mounting system 600 is to be used with a firearm. It may be advantageous to mount that firearm without any modifications that would prevent its handheld use by an operator. As such, first bracket 630 may be sized and shaped to securely fasten a fore grip of the firearm and second bracket 632 may be sized and shaped to securely fasten a pistol grip of the firearm to first member 602. Moreover, mounting system 600 includes a device actuator 634 configured to operate device 300. In the firearm example, device actuator 634 would be configured to pull a trigger of the firearm. As discussed above, while the example shown is for a firearm, it should be understood that first and second brackets 630, 632 and device actuator 634 may be configured for securing and operating any device 300. Mounting system 600 further includes a second member 608 configured for removably coupling mounting system 600 to aircraft 100. Second member 608 may include structure similar to mounting system 200 for coupling to aircraft 100. First member 602 is coupled to second member 608 via a plurality of actuators 618. Actuators 618 include swivel joints 626 at both ends thereof for coupling actuators 618 to first member 602 and second member 608. Actuators 618 are oriented in a manner that enables movement of first member 602 relative to second member 608 in six degrees of freedom. As such, mounting system 600 may eliminate the need for a deployment apparatus as mounting system 600 itself may move device 300 from a store position to a deployed position in addition to enabling directional movement thereof.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A mounting system configured to couple a device to a vehicle and provide for movement and remote operation of the device, the mounting system comprising:
a first member configured for removably coupling the device to the mounting system;
a second member rotatably coupled to the first member;
a rotational actuator configured to rotate the first member relative to the second member about a first axis;
a linear actuator, wherein actuation of the linear actuator causes movement the first member and the second member together;
a device actuator configured to operate the device; and
a deployment apparatus configured to move the device from a stored position to a deployed position.

2. The mounting system of claim 1, wherein the first member is configured to permit decoupling of the device from the first member without the use of a tool.

3. The mounting system of claim 1, wherein the deployment apparatus comprises a telescoping system configured to translate the device from the stored position to the deployed position.

4. The mounting system of claim 1, wherein the deployment apparatus comprises a rotating system configured to rotate the device with the first and second members to the deployed position.

5. The mounting system of claim 1, wherein the rotational actuator comprises a motor coupled to the second member, the motor being configured to transfer rotational energy to the first member.

6. The mounting system of claim 5, wherein the linear actuator comprises an electromagnetic linear actuator rotatably coupled to the second member and being configured to be coupled to the vehicle.

7. The mounting system of claim 6, further comprising a second electromagnetic linear actuator rotatably coupled to the second member and configured to be coupled to the vehicle, thereby being capable of causing translation and rotation of the first and second members.

8. The mounting system of claim 1, further comprising:
a controller configured to transmit control signals;
a processor configured to receive the control signals and transmit corresponding movement signals to the rotational, linear, and device actuators; and
a power source configured to power the processor and the rotational, linear, and device actuators.

9. The mounting system of claim 8, wherein the mounting system is configured to be decoupled from the vehicle without a tool.

10. The mounting system of claim 9, wherein the mounting system is configured to facilitate use of the device when the mounting system is not coupled to the vehicle.

11. A mounting system configured to couple a device to a vehicle and provide for movement and remote operation of the device, the mounting system comprising:
a first member configured for removably coupling the device to the mounting system;
a second member configured for removably coupling the mounting system to the vehicle;
a plurality of actuators coupled between the first and second members, the plurality of actuators being configured to enable movement of the first member relative to the second member in six degrees of freedom; and
a device actuator configured to operate the device.

12. The mounting system of claim 11, further comprising:
a controller configured to transmit control signals;
a processor configured to receive the control signals and transmit corresponding signals to the plurality of actuators and the device actuator; and
a power source configured to power the processor, the plurality of actuators, and the device actuator.

13. The mounting system of claim 12, wherein the mounting system is configured to be decoupled from the vehicle without a tool and the mounting system is configured to facilitate use of the device when the mounting system is not coupled to the vehicle.

14. An aircraft configured to deploy a device therefrom, the aircraft comprising:
a fuselage having a front portion and an opposite tail portion, the fuselage defining an opening in the tail portion;
a panel being movable from a closed position, covering the opening in the tail portion of the fuselage, to an open position;
a mounting system, comprising:
a first member configured for removably coupling the device to the mounting system;
a second member rotatably coupled to the first member;
a rotational actuator configured to rotate the first member relative to the second member about a first axis;
a linear actuator, wherein actuation of the linear actuator causes movement of the first and second members together;
a device actuator configured to operate the device; and
a deployment apparatus configured to move the device from a stored position to a deployed position.

15. The aircraft of claim 14, further comprising:
a controller configured to transmit control signals;
a processor configured to receive the control signals and transmit corresponding movement signals to the rotational, linear, and device actuators; and
a power source configured to power the processor and the rotational, linear, and device actuators.

16. The aircraft of claim 15, wherein the mounting system is configured to be decoupled from the vehicle without a tool and the mounting system is configured to facilitate use of the device when the mounting system is not coupled to the vehicle.

17. The aircraft of claim 16, wherein the rotational actuator comprises a motor coupled to the second member, the motor being configured to transfer rotational energy to the first member.

18. The aircraft of claim 16, wherein the linear actuator comprises an electromagnetic linear actuator rotatably coupled to the second member and being configured to be coupled to the vehicle.

19. The aircraft of claim 18, wherein the deployment apparatus comprises a telescoping system configured to translate the device from the stored position to the deployed position.

20. The aircraft of claim 18, wherein the deployment apparatus comprises a rotating system configured to rotate the device with the first and second members to the deployed position.
